(19) United States
(12) Patent Application Publication
(10) Pub. No.: US 2006/0280062 A1
(43) Pub. Date: Dec. 14, 2006

(54) Optical disc apparatus

(75) Inventor: Kazuo Ichihara, Daito-shi (JP)

Correspondence Address: PILLSBURY WINTHROP SHAW PITTMAN, LLP, P.O. BOX 10500, MCLEAN, VA, 22102, US

(73) Assignee: Fuani ELectric Co., Ltd., Osaka (JP)

(21) Appl. No.: 11/438,437

(22) Filed: May 23, 2006

(30) Foreign Application Priority Data
May 24, 2005 (JP) 2005-150852

(51) Int. Cl. G11B 7/00

(52) U.S. Cl. 369/44.32

(57) ABSTRACT

When an optical disc is mounted therein, an optical disc apparatus measures a tilt angle of an objective lens for an outer radial position on the optical disc, i.e., an outer tilt angle. Based on the outer tilt angle as measured and a preset inner tilt angle, the apparatus calculates a relationship between radial positions on the optical disc and tilt angles corresponding to the respective radial positions. In recording or reading data on or from the optical disc, the apparatus tilts the objective lens, according to the calculated relationship, at a tilt angle corresponding to a data recording position or a data reading position.

### CROSS REFERENCE

This Non provisional application claims priority under 35 U.S.C.§119(a) on patent application No. 2005-150852 filed in Japan on May 24, 2005, the entire contents of which are hereby incorporated by reference.

### BACKGROUND OF THE INVENTION

The invention relates to an optical disc apparatus adapted to record data on optical discs, such as compact discs (CDs) or digital versatile discs (DVDs), or retrieve data stored on such discs.

There have been proposed optical disc apparatuses provided with a tilt angle adjusting mechanism that allows laser radiation from a pickup assembly to be incident on a recorded surface of an optical disc at right angles. Such apparatuses are disclosed in JP 2002-260263A and JP 2003-263764A. The tilt angle adjusting mechanism is provided for reducing negative influences of disc warpage on accuracy of recording or reading data on or from optical discs in order to improve the accuracy. The pickup assembly has an objective lens for focusing the laser radiation on a recorded surface of an optical disc. The tilt angle adjusting mechanism adjusts an angle at which the objective lens is tilted with respect to the recorded surface. Such angle is hereinafter referred to merely as the tilt angle. The proposed tilt angle adjusting mechanisms are adapted to tilt the pickup assembly itself or to tilt the objective lens instead of the pickup assembly.

JP 2002-260263A also discloses a tilt sensor for detecting a deviation of an angle of incidence of focused laser radiation on the recorded surface from the right angle. The tilt angle adjusting mechanism of the reference is configured to adjust a tilt angle according to an output of the tilt sensor. This configuration allows tilt angle adjustments to be made according to an amount of disc warpage in a data recording position, or a data reading position, on an optical disc. The data recording and reading positions are hereinafter referred to collectively as the access position. The access position is where the focused laser radiation is incident on the recorded surface.

In the meanwhile, JP 2003-263764A discloses that, upon mounting of an optical disc in the apparatus, a tilt angle is measured with the objective lens located at an intermediate radial position and that the measured tilt angle is used as a fixed tilt angle. The term “intermediate radial position” used therein means a position at a radius R from the center of optical disc. The radius R is calculated from the following equation: R=(R1+R2)/2,

where R1 is an inner recording radius of the optical disc, and R2 is an outer recording radius of the same.

However, the configuration as disclosed in JP 2002-260263A requires the separate tilt sensor and leads to increased manufacturing costs. JP 2002-260263A further discloses that, upon mounting of an optical disc in the apparatus, a tilt angle is measured with the objective lens located at each of an inner radial position and an outer radial position and that the tilt angle adjusting mechanism is deactivated when a difference of smaller value than a predetermined value is observed between the measured tilt angles, i.e., when the optical disc has a small warpage. This configuration involves a fixed tilt angle as well. Generally, optical discs are not warped at a constant rate along the radial direction thereof, but have a increasingly greater amount of warpage toward outer edges thereof. It follows that an appropriate tilt angle becomes greater toward the outer edge. Thus, the prior art apparatuses employing the fixed tilt angle has the following inherent problem. The apparatuses cannot properly adjust the tilt angle according to amount of disc warpage in an access position, thereby causing a high frequency of data recording/reading errors.

Alternatively, a tilt angle could be adjusted according to an amount of disc warpage in an access position, without a tilt sensor, by a method that includes the steps of:
(1) measuring respective tilt angles, upon mounting of an optical disc, with the objective lens located at a plurality of positions at different radii from the center of the optical disc; and
(2) tilting the objective lens at a selected one of the measured tilt angles according to an access position.

However, the method requires a longer time to execute a mounting process, thereby rendering the apparatus less user-friendly.

In light of the foregoing, a feature of the invention is to provide a user-friendly, inexpensive optical disc apparatus that allows a tilt angle to be adjusted according to amount of warpage of an optical disc measured at an access position.

### SUMMARY OF THE INVENTION

An optical disc according to an aspect of the invention includes a tilt angle adjusting means for tilting an objective lens, which is provided for focusing a laser beam on a recorded surface of an optical disc, at an angle with respect to the recorded surface. When an optical disc is mounted therein, the apparatus measures a tilt angle of the objective lens corresponding to an outer radial position on the optical disc, i.e., an outer tilt angle. Based on the outer tilt angle as measured and a preset inner tilt angle for an inner radial position on an arbitrary optical disc, the apparatus calculates a relationship between radial positions on the optical disc and tilt angles corresponding to the respective radial positions.

Generally, an optical disc has a warpage of such shape that is approximated by a quadratic function. Thus, a relationship between radial positions on an optical disc and tilt angles corresponding to the respective radial positions can be approximated by a linear function. Also,. an optical disc generally has an increasingly smaller amount of warpage toward the center thereof, and is almost flat at the center. In other words, a tilt angle is approximately zero around the center of the optical disc. The linear function, which approximates the relationship between the radial positions and the tilt angles corresponding to the respective radial positions, is hereinafter referred to as a tilt function. If an inner tilt angle is preset to a value such as of “zero”, the tilt function can be calculated by measuring only an outer tilt angle.

In recording or reading data on or from the optical disc, the apparatus tilts the objective lens, according to the calculated relationship, at a tilt angle corresponding to an access position, i.e., a data recording position or a data reading position.

Only an outer tilt angle is measured when an optical disc is mounted. Thus, the optical disc apparatus allows a shortened mounting process time and enhances user-friendliness. Also, the optical disc apparatus allows tilt angle adjustments to be made according to an amount of warpage of an optical disc in an access position, without use of a tilt sensor, resulting in a reduced frequency of data recording errors or data reading errors, as well as in enhanced reliability and reduced manufacturing costs.

The term “inner radial position on optical disc” used herein means a position on an inner edge of a recording area of the optical disc, whereas the term “outer radial position on optical disc” means a position on an outer edge of the same.

### BRIEF DESCRIPTION OF THE DRAWINGS

FIG. 1 is a block diagram for illustrating a configuration of an optical disc apparatus according to an embodiment of the invention;

FIG. 2 is a schematic diagram for illustrating a construction of the optical disc apparatus;

FIG. 3 is a graph for showing tilt angles measured at respective radial positions on an optical disc;

FIG. 4 is a flowchart for illustrating a process for calculating a tilt angle performed by the optical disc apparatus; and

FIG. 5 is a flowchart for illustrating a process for adjusting a tilt angle performed by the optical disc apparatus.

### DETAILED DESCRIPTION OF THE INVENTION

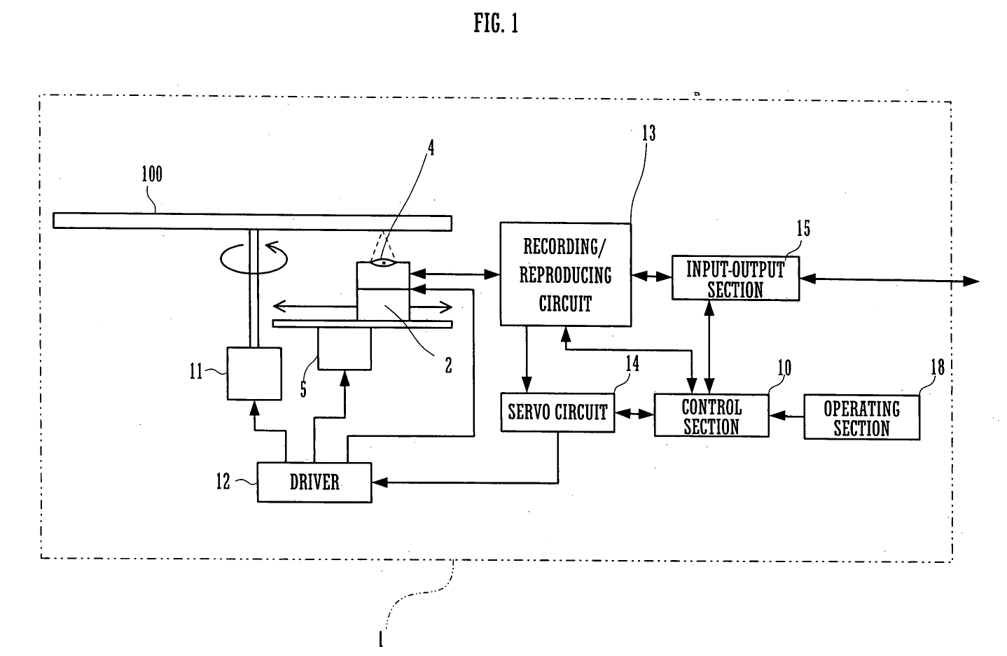

FIG. 1 is a block diagram for illustrating a configuration of an optical disc apparatus according to an embodiment of the invention. FIG. .2 is a schematic diagram for illustrating a construction of the optical disc apparatus. A control section 10 has overall control over an optical disc apparatus 1. The apparatus 1 includes a pickup assembly 2. The assembly 2 focuses laser radiation onto an optical disc 100. The assembly 2 has a laser diode (LD), a photodiode (PD), and an objective lens 4. The LD serves as a light source to emit laser radiation toward the disc 100. The PD is used to detect light reflected by the disc 100. The lens 4 is used to focus the laser radiation onto a recorded surface of the disc 100. The assembly 2 also has a focusing actuator, a tracking actuator, and a tilting actuator. The focusing actuator moves the lens 4 close to, and away from, the disc 100. The tracking actuator moves the lens 4 along a radial direction of the disc 100. The tilting actuator tilts the lens 4 with respect to the recorded surface of the disc 100. The assembly 2 is movably mounted to the apparatus 1 with a shaft that extends along the radial direction of the disc 100. A thread motor 5 moves the assembly 2 along the shaft along the radial direction.

A spindle motor 11 spins the disc 100. A driver 12 sends out a driving signal to each of the triaxial actuators, the motor 5, and the motor 11. A recording/reproducing circuit 13 generates a focusing error (FE) signal, a tracking error (TE) signal, a reading [radio-frequency (RF)] signal, a light pulse signal, and the like. The FE signal indicates a deviation of a laser focus position from the recorded surface. The TE signal indicates a deviation of a laser incident position from center of a data track formed in the disc 100. The RF signal is a read signal for data stored in the disc 100. The light pulse signal is a signal generated according to data to be stored in the disc 100. The circuit 13 processes the RF signal., and inputs a resulting reproducing signal to an input-output section 15. The section 15 in turn outputs the reproducing signal. The section 15 also inputs an externally input recording signal to the circuit 13. The circuit 13 generates, and outputs, a light pulse signal based on the input recording signal. The light pulse signal is input to a drive circuit for the LD.

The circuit 13 inputs the FE signal and the TE signal to a servo circuit 14. Also, the section 10 inputs, to the circuit 14, a control signal for controlling rotation speed of the motor 11, a tilt control signal for indicating an angle at which the lens 4 is to be tilted with respect to the recorded surface of the disc 100, and the like. According to those input signals, the circuit 14 generates respective drive control signals for the triaxial actuators, the motor 5, and the motor 11, and inputs the drive control signals to the driver 12. According to the signals, the driver 12 sends out respective driving signals to the triaxial actuators, the motor 5, and the motor 11, in order to actuate them, as described earlier.

An operating section 18 has a plurality of operation keys, a remote-control signal receiving section, and the like. The operation keys are provided for operation by a user. The remote-control signal receiving section receives a remote-control signal sent out from a remote control.

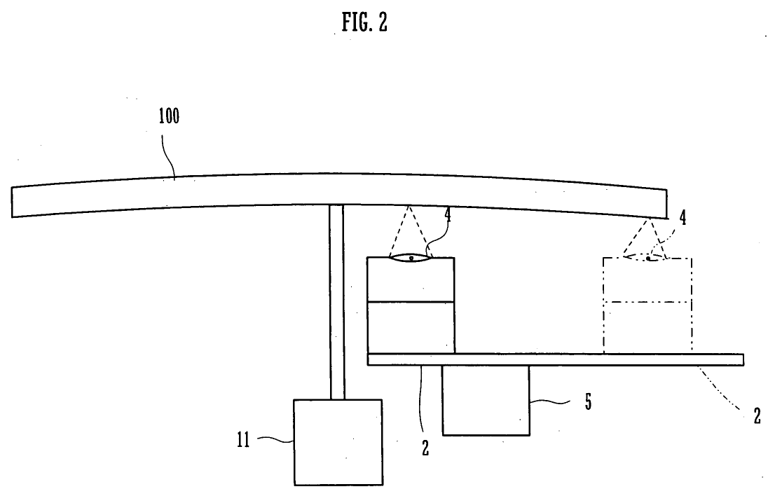

Referring to FIG. 2, the disc 100 generally is almost flat at the center, and has an increasingly greater amount of warpage toward an outer edge thereof. In order for a laser beam to be incident at right angles to the recorded surface of the disc 100, thus, it is necessary to tilt the lens 4 at an increasingly greater angle as a data recording position or a data retrieving position, i.e., an access position, proceeds toward the outer edge.

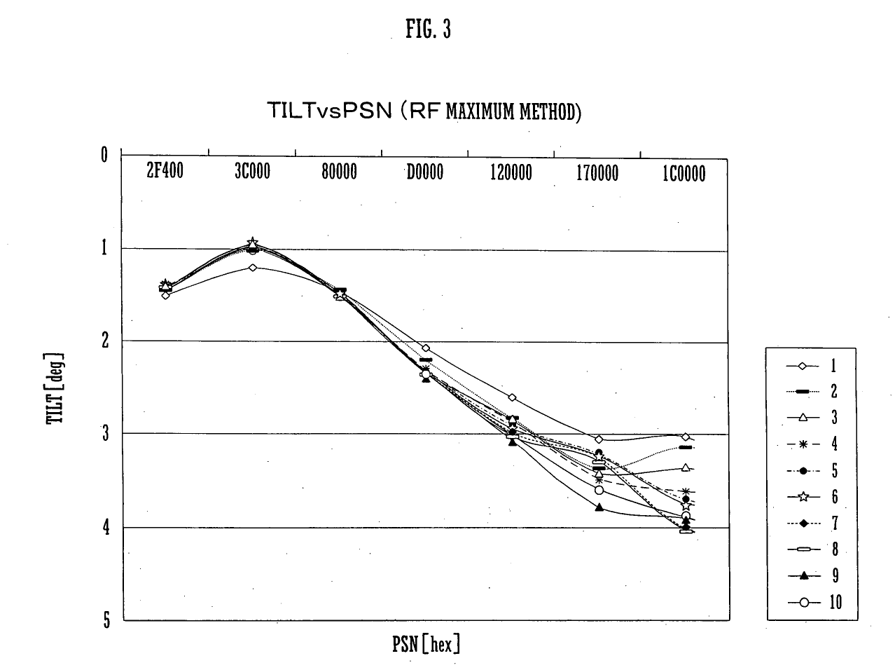

Generally, the disc 100 has a warpage of such shape that is approximated by a quadratic function. Thus, a relationship between radial positions on the disc 100 and tilt angles corresponding to the respective radial positions can be approximated by a linear function. The term “radial positions” herein means positions at different radii from the center of the disc 100. The linear function is hereinafter referred to as a tilt function. This is clear from FIG. 3, which shows results of ten measurements of tilt angle conducted with respect to each of a plurality of radial positions. Referring to FIG. 3, an ordinate axis represents tilt angles [unit:deg], whereas an abscissa axis represents respective addresses corresponding to the radial positions. It is to be noted that the disc 100 is remounted before each measurement. Based on the measurement results, it has been determined that a tilt angle measured at an inner radial position on the disc 100 is very small and shows minor variations caused by mounting conditions.

The measurements are conducted by an “RF maximum method” to be described later.

Hence, the tilt function, which represents the relationship between the radial positions and the tilt angles corresponding to the respective radial positions, is determined from knowing respective tilt angles for the inner radial position and an outer radial position on the disc 100 as mounted in the apparatus 1. Because of the minor variations caused by mounting conditions, in addition, the tilt angle for the inner radial position can be preset to an appropriate value, e.g., 0 degree. Therefore, the tilt function can be determined by measuring a tilt angle for the outer radial position.

The term “inner radial position on the disc 100” herein means a position on an inner edge of a recording area of the disc 100, whereas the term “outer radial position on the disc 100” means a position on an outer edge of the same.

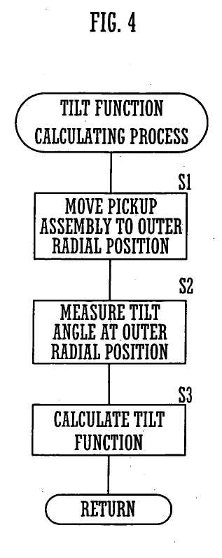

Next, described below is an operation performed by the optical disc apparatus 1. When the optical disc 100 is mounted therein, the apparatus 1 executes a process for calculating a tilt function with regard to the disc 100, i.e., a tilt function calculating process. FIG. 4 is a flowchart for illustrating the tilt function calculating process. The apparatus 1 moves the pickup assembly 2 to the outer radial position on the disc 100 (step S1) and measures a tilt angle of the lens 4 for the outer radial position (step S2). At step S2, the apparatus 1 varies the tilt angle in stages, and detects amplitude of RF signal at each stage. The apparatus 1 detects, as an outer tilt angle, a tilt angle corresponding to a maximum amplitude of the RF signal. Specifically, the apparatus 1 measures the outer tilt angle by the “RF maximum method”.

It is to be noted that an outer tilt angle may alternatively be measured by other methods than the RF maximum method.

The apparatus 1 uses the outer tilt angle as detected at step S2, together with a preset inner tilt angle, to calculate a tilt function (step S3). The tilt function represents a relationship between radial positions on the disc 100 as mounted and respective tilt angles corresponding to the radial positions.

The tilt function is linear, as described earlier. Data on the inner tilt angle is prestored in a memory, or the like, that is provided in the control section 10. In the memory, the apparatus 1 stores the calculated tilt function.

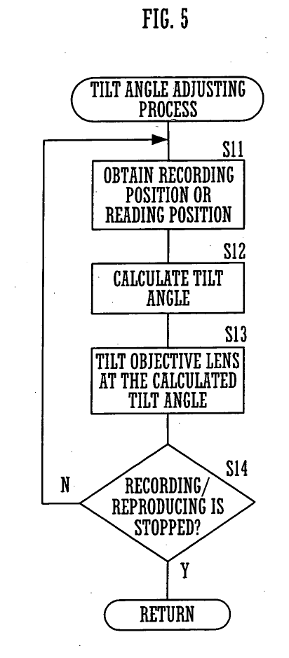

Next described is a tilt angle adjusting process that the apparatus 1 performs in recording or reproducing data. FIG. 5 is a flowchart for illustrating the tilt angle adjusting process. The tilt angle adjusting process is repeated for duration of data recording or reproducing on or from the disc 100. The apparatus 1 obtains a current access position on the disc 100 (step S11). Either a radial position on the disc 100 or an address corresponding to the radial position may be obtained as the access position. According to the tilt function as calculated at step S3, the apparatus 1 calculates a tilt angle for the obtained access position (step S12). Then, the apparatus 1 makes such adjustments that the lens 4 is tilted at the calculated tilt angle (step S13). At step S13, the section 10 indicates to the servo circuit 14 an angle at which the lens 4 is to be tilted, so that the circuit 14 generates a drive control signal to be input to the driver 12. According to the drive control signal, the driver 12 tilts the lens 4. The apparatus 1 repeats the sequence of steps S11 to S13 until determination is made that data recording or reproducing is stopped (step S14).

Accordingly, the foregoing configuration allows tilt angle adjustments to be made according to an amount of warpage of the disc 100 in an access position, without use of a tilt sensor. The configuration thus reduces frequency of data recording errors or data reading errors, thereby enhancing reliability of the apparatus, while reducing manufacturing costs.

Moreover, only an outer tilt angle is measured when the disc 100 is mounted. Thus, the configuration allows a mounting process time to be shortened, thereby rendering the apparatus user-friendly.

The invention being thus described, it will be obvious that the same may be varied in many ways. Such variations are not to be. regarded as a departure from the spirit and scope of the invention, and all such modifications as would be obvious to one skilled in the art are intended to be included within the scope of the following claims.

What is claimed is:

1. An optical disc apparatus provided with a pickup assembly that has an objective lens for focusing a laser beam on a recorded surface of an optical disc, the optical. disc apparatus comprising:
a tilt angle adjusting means for tilting the objective lens at an angle with respect to the recorded surface;
a measuring means for measuring, as an outer tilt angle, an angle at which the objective lens is tilted with respect to an outer radial position on the optical disc with the laser beam being incident at right angles to the recorded surface, when the optical disc is mounted; and
a calculating means for calculating a relationship between radial positions on the optical disc and tilt angles corresponding to the respective radial positions based on the outer tilt angle as measured and a preset inner tilt angle for an inner radial position on an arbitrary optical disc,
wherein the tilt angle adjusting means tilts the objective lens, according to the calculated relationship, at an angle corresponding to a radial position where the laser beam is to be focused.

2. The optical disc apparatus according to claim 1,
wherein the calculating means calculates a linear function that represents the relationship between the radial positions and the corresponding tilt angles.
